(19) United States
(12) Patent Application Publication
(10) Pub. No.: US 2022/0044148 A1
(43) Pub. Date: Feb. 10, 2022

(54) ADAPTING PREDICTION MODELS

(71) Applicant: KONINKLIJKE PHILIPS N.V., EINDHOVEN (NL)

(72) Inventors: Aki Sakari Härmä, Eindhoven (NL); Andrei Poliakov, Moscow (RU); Irina Fedulova, Moscow (RU)

(21) Appl. No.: 17/281,409

(22) PCT Filed: Oct. 10, 2019
(86) PCT No.: PCT/EP2019/077465

§ 371 Date: Mar. 30, 2021

(30) Foreign Application Priority Data
Oct. 15, 2018 (RU) 2018136281

(51) Int. Cl. G06N 20/00

(52) U.S. Cl. CPC G06N 20/00

(57) ABSTRACT

A method and system for modifying a prediction model. In particular, an inaccuracy of the prediction model is categorized into one of at least three categories. Different modifications are made to the prediction model depending on the category of the inaccuracy. In particular examples, an inaccuracy category defines what training data is used to modify the prediction model.

### FIELD OF THE INVENTION

The present invention relates to prediction models, and in particular to methods and systems for adapting prediction models.

### BACKGROUND OF THE INVENTION

Prediction models, such as deep learning models, are increasingly used in data analysis tasks, such as image analysis and speech recognition. Generally, a prediction model is applied to input data to predict an answer to a desired task or question, i.e. generate “predicted answer data”.

A typical prediction model is formed of a series of analysis steps, which are sequentially applied to input data to thereby generate the predicted answer data, which is indicative of a predicted result of a desired task or question. Each analysis step is commonly called a “layer” of the prediction model.

A prediction model is usually tuned to perform a specific task, i.e. trained to answer a specific question, using training data. This process involves collecting training data, formed of input data and corresponding actual/known answer data, indicative of an actual/known answer to the desired task/question. A generic prediction model is then applied to input data of the training data to generate predicted answer data (i.e. being the prediction model's prediction of the actual answer data). Parameters of this generic prediction model are then modified based a comparison between the predicted answer data and the actual answer data (obtained from the training data), in order to improve a performance of the prediction model. This training process can be iteratively repeated. The modified prediction model can then be applied to new instances of input data to accurately predict answer data.

However, one problem of prediction models is that (once trained) it is assumed that the prediction model will continue to accurately predict answer data, which assumption does not always hold true. In particular, the nature of the input data and/or the accuracy of the prediction model may change over time, a phenomenon known as “drift”. In particular, the relationship between input data and actual answer data may change over time, e.g. if the nature/format of the input data changes.

In order to detect the occurrence of drift, new/updated training data may be provided. The prediction model can then be applied to input data of the new training data, to generate appropriate predicted answer data, which is then compared to known answer data provided by the new training data. In this way, an accuracy of the prediction model may be assessed, and drift detected.

Traditionally, if it is determined that an existing prediction model is inaccurate, a new prediction model is built from scratch using new training data, to ensure that the prediction model is accurately brought up-to-date. However, generation of a prediction model requires a significant amount of (training) data, time and processing power. There is therefore a desire for an improved method of generating a prediction model.

### SUMMARY OF THE INVENTION

The invention is defined by the claims.

According to examples in accordance with an aspect of the invention, there is provided a method of modifying a prediction model, wherein the prediction model is generated based on existing training data and is adapted to process input data to generate predicted answer data indicative of a predicted answer to a predetermined question concerning the input data. The method comprises performing a difference determination step comprising: receiving benchmark data, the benchmark data comprising example input data and corresponding actual answer data indicative of an actual or known answer to the predetermined question concerning the corresponding example input data; using the prediction model to process the example input data to generate predicted answer data indicative of a predicted answer to the predetermined question based on the example input data; and determining a difference between the actual answer data and the predicted answer data. The method also comprises categorizing an inaccuracy of the prediction model into one of at least three categories based on at least the difference between the actual answer data and the predicted answer data; and modifying the prediction model based on the category of inaccuracy of the prediction model.

Embodiments of the present invention recognize that a prediction model can lose accuracy over time due to changing data conditions (i.e. due to drift). Thus, a difference between predicted answers and actual answers to a predetermined question or task may change, so that the predictions of the prediction model begin to “drift” from the actual answers. In other words, a relationship between input data and an actual answer to a question (based on that input data) is capable of changing or drifting. This means that a prediction model (which may have initially been highly accurate) can become less accurate over time.

Embodiments of the present invention also advantageously recognizes that there are different causes or reasons for this change in the relationship between input data and actual answer data. In particular, embodiment of the present invention recognize that it would not be suitable to apply a single modification technique to a prediction model if it is determined that a prediction model is no longer sufficiently accurate. Thus, different model modification techniques can be employed to modify the prediction model based on a category or identified cause of the difference.

In this way, a modification to the prediction model may accurately reflect the cause of a change in accuracy of the prediction model. This avoids the need to entirely rebuild a prediction model when a change in accuracy of the prediction model is identified.

There is a strong technical incentive to improve prediction models, as they are often used to perform a technical task (e.g. recommend a treatment of a patient or calculate control parameters for a manufacturing device). Thus, improving a general prediction model has a direct effect on the processing performance and accuracy of a processing element using the prediction model.

Preferably, the at least one category for the inaccuracy of the prediction model comprises a category indicating that no drift or significant change in prediction model accuracy has occurred. Accordingly, the step of modifying the prediction model may comprise performing no modification on the prediction model in response to determining that no drift or significant change in prediction model accuracy has occurred.

In some embodiments, the difference determination step is iteratively repeated to generate a plurality of differences between actual answer data and corresponding predicted answer data; and the step of categorizing the inaccuracy of the prediction model comprises: identifying a pattern in the plurality of differences; and categorizing the inaccuracy based on the identified pattern in the plurality of differences.

In other words, the present invention proposes to identify patterns in differences between actual data/values and corresponding predicted data/values. The identified patterns can be used to categorize or otherwise identify an accuracy of a prediction model.

It has been recognized that a pattern of differences between actual and predicted data can be used to closely represent an inaccuracy of the prediction model; whilst outlying differences can be ignored (i.e. they do not fall within a pattern). Thus, using a pattern enables drift to be more accurately characterized.

Preferably, the step of identifying a pattern in the plurality of differences comprises determining whether there is a step change in the differences; and in response to determining that there is a step change in the differences over time, the step of categorizing the inaccuracy comprises categorizing the inaccuracy as a sudden drift.

Thus a step or “sudden” change in the differences can be identified. A sudden change in the differences between predicted data and actual data can be indicative that there has been a sudden drift or change in accuracy of the prediction model. Sudden changes in the accuracy of the model can therefore be identified and accounted for when modifying the prediction model.

In further embodiments, in response to categorizing the inaccuracy as a sudden drift, the step of modifying the prediction model comprises rebuilding a new prediction model based on new training data for the prediction model. In particular, existing or old training data used to train the prediction model is discarded, and a new prediction model based on new training data is prepared (i.e. without using existing training data).

In other words, it has been recognized that if a sudden drift has occurred, existing training data is out-of-date, so that an existing prediction model is considered to be completely inaccurate (i.e. unable to accurately identify an answer to the predetermined question with suitable certainty). The existing training data may be discarded, and a new prediction model generated based on new training data. This ensures that the prediction model is updated to new training data, and it suitable accurate.

When a sudden drift has occurred, old training data may no longer accurately represent a relationship between input data and actual answer data—i.e. the characteristics of the data have changed. It would therefore be important to generate a new prediction model to ensure accurate determination of a relationship between input data and actual answer data is provided.

By only rebuilding a new prediction model when a sudden drift is detected, a reduction in the amount of (training) data, time and processing power required to modify/correct a training model is made.

The method may comprise determining whether there is a step change in the differences over time comprises determining whether a standard deviation of the differences during a time window is greater than a first predetermined value.

This provides a simple, but accurate, method of identifying when a sudden shift (i.e. step change) in the inaccuracy of the prediction model has occurred, thereby minimizing a processing power required to identify when a sudden drift has occurred.

In at least one embodiment, the step of identifying a pattern in the plurality of differences comprises determining whether there is a gradual change in the differences over time; and in response to determining that there is a gradual change the differences over time, the step of categorizing the inaccuracy comprises categorizing the inaccuracy as a gradual drift.

A gradual change in the differences over time can indicate that the accuracy of the prediction model is slowly changing. Thus, existing training data may not be entirely out of date, and the prediction model may continue to predict answer data with a suitably high degree of accuracy without needing substantial correction or modification.

Optionally, in response to categorizing the inaccuracy as a gradual drift, the step of modifying the prediction model comprises appending new training data to existing training data, and rebuilding a new prediction model based on the appended training data.

In other words, the prediction model may be refined using new training data, however, existing training data may also be employed when refining the prediction model (as the existing training data may continue to represent suitable examples of a relationship between input data and answer data). By continuing to use existing training data, an amount of (training) data, time and processing power required to modify the prediction model is reduced. This is because the unmodified prediction model (trained using the existing training data) will more closely resemble the modified prediction model than, say, a generic prediction model used to build a prediction model from scratch. Thus, fewer iterations for suitably modifying a prediction model (e.g. having a minimum level of accuracy) need to be taken.

The step of modifying the prediction model may further comprise discarding a temporally earliest portion of the existing training data, preferably wherein the size of the discarded temporally earliest portion is a same size as the new training data appended to the existing training data.

Thus, the training data used to modify the prediction model may temporally track newly available training data so as to reflect a changing trend in the relationship between input data and actual answer data. This improves the accuracy of the prediction model.

The step of determining whether there is a gradual change in the differences preferably comprises determining whether a standard deviation of the differences during a time window is between a second predetermined value and a third predetermined value. This provides a simple, but accurate, method of identifying when a gradual or incremental shift (i.e. gradual change) in the inaccuracy of the prediction model has occurred. This reduces a processing power required to determine whether a gradual/incremental shift is occurring.

In some embodiments, the step of identifying a pattern in the plurality of differences comprises determining whether there is a periodic change in the differences. Preferably, in response to determining that there is a periodic change in the differences, the step of categorizing the inaccuracy comprises categorizing the inaccuracy as a periodic drift; and optionally, in response to categorizing the inaccuracy as a periodic drift, the step of modifying the prediction model comprises obtaining new training data and iteratively modifying the prediction model by iteratively: obtaining integrated training data formed of a portion of the existing training data and a portion of the new training data; and modifying the prediction model based on the integrated training data, wherein the size of the portion of the new training data and the size of the portion of the existing training data in the integrated training data is modified for each iteration of modifying the prediction model.

A periodic shift causes the relationship between input data and actual output data to vary periodically with time. Thus, a (static or unchanging) prediction model may initially be accurate, then become inaccurate and then become accurate once again—as the relationship between input data and actual output data varies over time.

It is therefore proposed to identify the periodic changes (e.g. over the course of a period of time, such as a day, week, month or year) to the accuracy of the prediction model.

If a periodic drift is identified, it is proposed to iteratively vary a ratio between new and existing training data used to form the integrated training data (subsequently used to modify the prediction model). In particular, the proportions of the new and existing training data may track the periodic change in the differences—i.e. so that the prediction model is iteratively modified to track the change in the differences.

Thus, the prediction model may be iteratively modification so that it follows a change in the relationship between input data and actual answer data. The speed of the iteratively modification may depend upon the period of the periodic shift. By recognizing a periodic drift and appropriately modifying the prediction model to align with the periodic drift, an accuracy of the prediction model can be maintained over time.

Moreover, by periodically switching between a ratio of new training data and existing training data, there is no need to discard or delete old training data. This leads to a reduced amount of data (e.g. past example) loss.

There is also proposed a method of modifying a prediction model, wherein the prediction model is adapted to process input data to generate predicted answer data indicative of a predicted answer to a predetermined question based on the input data. The method here comprises: determining a similarity between new input data for the prediction model and the existing training data used to train the prediction model; determining whether to modify the prediction model based on the determined similarity between the new input data and the existing training data; and in response to determining to modify the prediction model, performing any previously described method.

To avoid unnecessary rebuilding or modifications to a prediction model, a method may comprise determining whether input data (to be processed by the prediction model) is statistically different to example input data used to train the prediction model. It can be assumed that if there is no statistical difference (i.e. there is a similarity) between input data and example input data, then no drift has occurred—and the prediction model continues to accurately define a relationship between input data and answer data.

This reduces a processing power, by avoiding unnecessary modifications to the prediction model.

The step of determining a similarity between new input data and existing training data may comprise determining a similarity between statistical distributions of the new input data and the existing training data.

According to examples in accordance with an aspect of the invention, there is provided a computer program comprising code means for any previously described method when said program is run on a computer.

According to examples in accordance with another aspect of the invention, there is provided a system adapted for modifying a prediction model, wherein the prediction model is generated based on existing training data and is adapted to process input data to generate predicted answer data indicative of a predicted answer to a predetermined question concerning the input data. The system comprises a difference determination module adapted to perform a difference determination step by: receiving benchmark data, the benchmark data comprising example input data and corresponding actual answer data indicative of an actual or known answer to the predetermined question concerning the corresponding example input data; using the prediction model to process the example input data to generate predicted answer data indicative of a predicted answer to the predetermined question based on the example input data; and determining a difference between the actual answer data and the predicted answer data. The system also comprises a categorization unit adapted to categorize an inaccuracy of the prediction model into one of at least three categories based on at least the difference between the actual answer data and the predicted answer data; and a modification unit adapted to modify the prediction model based on the category of inaccuracy of the prediction model.

Preferably, the difference determination module is adapted to iteratively repeat the difference determination step to thereby generate a plurality of differences between actual answer data and corresponding predicted answer data; and the categorization unit is adapted to categorize the inaccuracy of the prediction model by: identifying a pattern in the plurality of differences; and categorizing the inaccuracy based on the identified pattern in the plurality of differences.

The inventors have recognized that a change or drift of the characteristics of the input data (also known as “concept drift”) may indicate that there is a change or drift in the relationship between the input data and the actual answer data, i.e. a drift in the prediction model. A method may therefore comprise: determining a difference between new input data for the prediction model and previous input data processed by the prediction model; determining whether to modify the prediction model based on the determined difference between the new input data and the previous input data; and in response to determining to modify the prediction model, performing any previously described method. This can reduce the processing power, by preventing or avoiding unnecessary assessment of the accuracy of the prediction model if there is no drift in the input data.

Detection of a change or drift in the input data is a complex task, especially if the input data is formed of textual data or an ontology (e.g. knowledge graph). It is also recognized that there are additional benefits to detecting change in input data, e.g. to enable users to identify changes in trends of input data for the purpose of improving research direction or understanding historical trends. There is therefore a desire to provide an accurate method of determining a change or drift of input data. A first step in determining a change or drift of input data is to determine or identify changes or transitions of concepts between two instances of input data.

There is therefore a need to detect concept drift within textual input data, which is a computationally complex task. It is known that textual input data can be processed to identify topics described or included within the textual input data.

There is proposed a method of characterizing concept drift within textual input data, by utilizing a new concept of an “attention flow model”. The attention flow model indicates how attention to a plurality of topics changes over time and to different instances of textual input data.

There is therefore proposed a concept of generating a plurality of measures of attention flow within a set of predetermined topics between first textual input data and second, different textual input data.

The method comprises: obtaining a plurality of topic vectors, each topic vector numerically representing a predetermined topic or concept so that a set of predetermined topics are represented by the plurality of topic vectors; measuring a similarity between each topic vector and each other topic vector to thereby provide a plurality of similarity measures; obtaining first textual input data and second, different textual input data; obtaining a first set of weights, each weight indicating a weighting of a respective topic of the set of predetermined topics within the first textual input data; obtaining a second set of weights, each weight indicating a weighting of a respective topic of the set of predetermined topics within the second textual input data, wherein the number of weights in the first and second set are the same and identical to the number of predetermined topics; and determining, a plurality of attention flow measures, each attention flow measure representing an attention flow from a respective predetermined topic within the first textual input data to a respective predetermined topic within the second textual input data, wherein the determining is based on the similarity measure associated with the respective predetermined topics and the weight, of the first set of weights, associated with the respective predetermined topic within the first textual input data and the weight, of the second set of weights, associated with the respective predetermined topic within the second textual input data.

The step of measuring a similarity between each topic vector may comprise determining a cosine similarity between each topic vector.

The step of determining a plurality of attention flow measures may comprise processing the similarity measures, the first set of weights and the second set of weights using a linear optimization algorithm.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 is a block diagram illustrating a method of modifying a prediction model according to an embodiment;

FIG. 2 is a block diagram illustrating a method of generating statistical analysis results using training data;

FIG. 3 is a block diagram illustrating a method of modifying a prediction model according to another embodiment;

FIG. 4 illustrates different patterns of differences for use in categorizing an inaccuracy of a prediction model;

FIGS. 5 to 7 illustrate different methods of modifying a prediction model based on a category of an inaccuracy of a prediction model;

FIG. 8 is a block diagram illustrating a method of modifying a prediction model according to another embodiment;

FIG. 9 illustrates a method for characterizing concept drift within textual input data by utilizing an attention flow model; and

FIG. 10 is a block diagram illustrating a system for modifying a prediction model according to an embodiment.

### DETAILED DESCRIPTION OF THE EMBODIMENTS

Embodiments of the invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

According to a concept of the invention, there is proposed a method and system for modifying a prediction model. In particular, an (in)accuracy of the prediction model is categorized into one of at least three categories. Different modifications are made to the prediction model depending on the category of the (in)accuracy. In particular examples, an (in)accuracy category defines what training data is used to modify the prediction model.

Embodiments are at least partly based on the realization that an accuracy of a prediction model may change in different manners or ways. Thus, there may be an improved efficiency by modifying the prediction model based on a category of the (in)accuracy of the prediction model.

Illustrative embodiments may, for example, be employed in patient risk prediction systems to ensure that a risk to a patient is accurately calculated.

By modifying a prediction model based on a classification of an inaccuracy of the prediction model, a more accurate prediction model may be obtained. This leads to more accurate prediction of answer data.

Thus, in a scenario in which the prediction model predicts a risk to a patient's health during hospital transfer (“hospital transfer risk”), modifying a prediction model according to propose concepts can lead to more accurate identification of the hospital transfer risk. This can lead to more efficient hospital resource planning due to the more accurate prediction of a hospital transfer risk.

Another possible scenario is where the prediction model is used to monitor user preferences are being monitored based on their social network activity to suggest content based on the detected preferences (i.e. the answer data is suggested content). By employing herein proposed concepts, the content suggestion will be more efficient, leading to better advertisement click-through rate.

Other scenarios in which a prediction model may be used to effect will be readily apparent to the skilled person.

As used herein, the term “prediction model” refers to a process or algorithm that is applied to input data in order to predict an answer to a predetermined question based on the input data. Thus, the prediction model performs a specified task on the input data to generate predicted answer data.

By way of example only, input data may comprise a medical image of a subject and the prediction model may be tuned to determine whether the medical image contains any tumors—i.e. the prediction model answers a question of whether the medical image contains tumors.

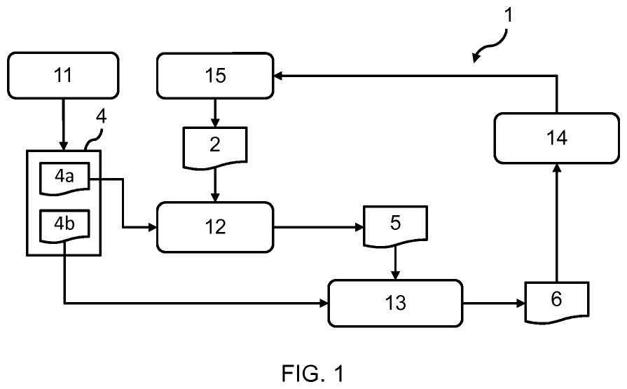

FIG. 1 is a block diagram illustrating a method 1 of modifying a prediction model 2 according to an embodiment.

The method 1 comprises a step 11 of obtaining benchmark data 4. The benchmark data 4 contains example input data 4a (for the prediction model) and actual answer data 4b associated with the example input data 4a. Thus, the actual answer data 4b represents a correct or actual answer to a question that the prediction model 2 is intended to answer. Actual answer data 4b may be otherwise called ‘ground truth data’.

The method 1 also comprises a step 12 of using the prediction model 2 to process the example input data 4a of the benchmark data 4 to generate predicted answer data 5. Thus, the prediction model attempts to answer a predetermined question based on the input data.

The benchmark data 4 may comprise a plurality of different data entries, each associated with a respective example input data entry and actual answer data entry. Step 12 may comprise generating a respective prediction answer data entry for each example input data entry. The benchmark data 4 preferably corresponds to example input and actual answer data for a particular period of time (e.g. an hour, day, week, month or year).

The method 1 then comprises a step 13 of comparing the predicted answer data 5 to the actual answer data 4b to determine a difference 6 between the actual answer data and the predicted answer data. The difference 6 is preferably a single value representing an accuracy or inaccuracy of the prediction model with respect to the benchmark data 4.

Step 13 may comprise, for example, performing a root mean square difference calculation on corresponding values contained in the predicted answer data and the actual answer data. Another possible method is to calculate an Area Under the Curve (AUC) value that indicates a correspondence between the actual answer data and the predicted answer data. As would be well known by the skilled person, an AUC value is essentially an integral over the Receiver Operator Characteristic curve (ROC), which represents the sensitivity and specificity of the prediction in different operating points.

Thus, step 13 may comprise determining an inaccuracy measure of the prediction model—the inaccuracy measure indicating how inaccurate the prediction answer data is compared to the actual answer data (i.e. how correctly the prediction model answered the predetermined question).

In other words, step 13 comprises evaluating a performance of the machine learning model, to thereby measure an inaccuracy of the prediction model. This measure can be obtained using any known learning classification metrics such as accuracy, precision, recall, ROC (Receiver operating characteristic) curve and AUC (Area Under Curve). It would be preferable to use metrics which are insensitive to skewness, such as AUC.

The preceding steps 11, 12, 13 can be considered to together form a difference determination step.

Method 1 then comprises a step 14 of categorizing the inaccuracy of the prediction model based on the difference 6, into one of at least three different categories. In particular, step 14 may comprise characterizing the difference 6 to thereby determine or categorize how accurately the prediction model predicted the answer data.

Step 15 of method 1 then modifies the prediction model 2 based on the categorization of the inaccuracy of the prediction model 2. In other words, the prediction model is modified or adapted based on a classification of the inaccuracy of the prediction model.

Step 14 may determine, for example, that the prediction model is sufficiently accurate (e.g. an inaccuracy measure is below a predetermined value). Step 14 may thereby classify the prediction model as “accurate”. In this case, step 15 may comprise not modifying the prediction model.

In another example, step 14 may determine that the prediction model is completely inaccurate, for example, that an inaccuracy measure is above a second predetermined value. Step 14 may thereby classify the prediction model as “very inaccurate”. In this case, step 15 may comprise rebuilding the prediction model from new training data (i.e. different to the existing training data used to produce the existing prediction model 2.

In yet another example, step 14 may determine that the prediction model is slightly inaccurate, for example, that an inaccuracy measure is between the first and second predetermined values. Step 14 may thereby classify the prediction model as “slightly inaccurate”. In this case, step 14 may comprise using both existing training data and new training data to refine the existing prediction model. For example, step 14 may comprise appending new training data to existing training data and retraining the prediction model based on the appended training data. The new training data may, for example, consist of the benchmark data 4. Preferably, a portion of the existing training data (e.g. equal in size to the new training data) is deleted or discarded, which portion is preferably an earliest acquired portion of the existing training data.

In this way, modifications made to the prediction model 2 depend upon the classification of the inaccuracy of the prediction model. This means that more appropriate adaptation of the prediction model 2 to reflect changing data trends can be provided.

Thus, in one scenario, the step 14 of categorizing the inaccuracy of the prediction model comprises categorizing the difference as corresponding to one of three categories.

Step 14 may be carried out, for example, by processing an inaccuracy measure using a nearest neighbors algorithm (to compare to known inaccuracy measures and their categories). Thus, step 14 comprises classifying or categorizing the inaccuracy of the prediction model. In other, preferred embodiments, categorization is performed using a machine learning model, as will be explained later. In some embodiments, categorization is performed based on a statistical analysis output of example outputs of the prediction model.

As previously explained, the difference 6 is preferably a numerical value or measure of the accuracy of the prediction model with respect to the benchmark data. In one example, the difference is calculated by determining a root mean square error between values of the predicted answer data 5 and corresponding values of the actual answer data 4b. By way of another example, the difference 6 may comprise an accuracy value A ranging from 0 to 1, indicating how closely the predicted answer data 5 matches the actual answer data 4b.

The first and second predetermined values, used above, may be generated by a statistical analysis of the training data used to generate the prediction model, in particular, to one or more differences established during training of the prediction model (or using training data used to train the prediction model), as will be explained below.

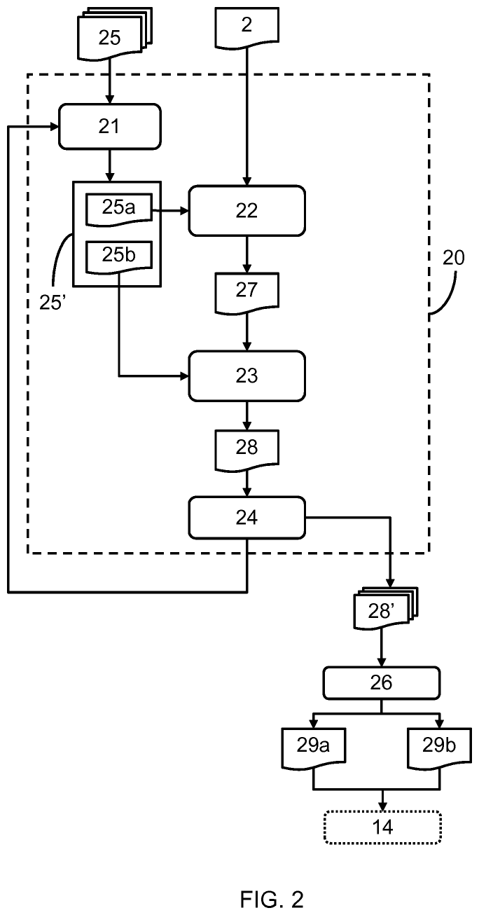

FIG. 2 illustrates a method of generating suitable statistical analysis results of training data. A brief description of how to train the prediction model is hereafter provided, to help contextualize the statistical analysis of the training data.

A trained prediction model 2 aims to establish the relationship between generic input data and generic answer data, so that the prediction model can process new input data and accurately predict associated answer data. To do so, training data 25 is provided to train or modify the prediction method 2. The training data 25 comprises multiple entries 25′ formed of sample input data 25a and corresponding actual sample answer data 25b. The actual sample answer data 25b represents an answer to a predetermined question based on the sample input data 25a.

During training, the generic prediction model is applied to each sample input data to generate a respective number of predicted sample answer data (i.e. each associated with a respective actual sample answer data). The prediction model is then modified with the aim of reducing an overall/average difference (e.g. accuracy value) between each predicted sample answer data and associated actual sample answer data. This process can be iteratively repeated (e.g. a predetermined number of times or until a difference is below a predetermined value).

The trained prediction model 2 can then be processed once more, with respect to the training data, to generate a plurality of differences 28′ between the trained prediction model 2 and the training data 2. Thus, a difference determination process 20 can be iteratively performed to generate a plurality of differences 28′ between predicted answer data (from applying prediction model to training data) and actual answer data (obtained from training data).

The difference determination process 20 comprises a step 21 of obtaining an entry 25′ of the training data 25, which entry 25′ is formed of sample input data 25a and actual sample answer data 25b. In step 22, the prediction model 2′ is applied to the sample input data 25a to generate predicted sample answer data 27. In step 23, a difference 28 between the predicted sample answer data 27 and the actual sample answer data 25b is calculated (e.g. an error value is determined). In step 24, this difference is stored to thereby contribute to a plurality of differences 28′ associated with the prediction model and the training data. The difference determination process 20 is repeated on each data entry of the training data, to thereby form the plurality of differences 28′.

The trained prediction model 2 (which can subsequently used on new input data) can thereby be associated with a plurality of differences 28′—representing differences between examples of actual sample answer data and predicated sample answer data.

These differences 28′ between the predicted sample answer data and the actual sample answer data (i.e. associated with the training data used to generate the prediction model) can be used to assess a current accuracy of the prediction model 2 with respect to the benchmark data (as used in FIG. 1).

In particular, statistical analysis results of the differences associated with the training data (used to generate the prediction model) are used to determine how outlying a difference between the predicted answer data 5 and the actual answer data 4b (of the benchmark data 4) is, and thereby how to categorize the inaccuracy of the prediction model.

Thus, there may be a step 26 of processing the differences 28′ associated with the trained prediction model 2 using one or statistical analysis methods to generate statistical analysis outputs 29a, 29b. These statistical analysis outputs 29a, 29b can be used in step 14 of categorizing a difference between predicted answer data and actual answer data (of benchmark data).

For example, the mean (μ) 29a and standard deviation (α) 29b of the differences 28′ associated with the training data 25 can be used to categorize the inaccuracy of the prediction model 2 based on the benchmark data 4.

In one example, if the difference 6 minus the mean (μ) of the differences associated with the training data is more than three standard deviations (3σ), the prediction model is categorized as being subject to “sudden drift”—i.e. an inaccuracy of the prediction is classified as being “inaccurate due to an sudden drift”. If the difference 6 minus the mean (μ) of the differences associated with the training data is between two (2σ) and three standard deviations (3σ), the prediction model is categorized as being subject to “incremental drift”—i.e. an inaccuracy of the prediction is classified as being “inaccurate due to an incremental drift”. If the difference 6 minus the mean (μ) of the differences associated with the training data is less than (2σ), the accuracy of the prediction model is categorized as being “accurate”—i.e. an inaccuracy of the prediction is classified as being “not inaccurate”.

Thus, the first predetermined value discussed above may be equal to three times the standard deviation (α) of the differences associated with the training data, and the second predetermined value may be equal to two times the standard deviation of the differences associated with the training data.

After a particular inaccuracy category is determined in step 14, step 15 modifies the prediction model 2 based on the determined category. Suitable modification methods will be described later.

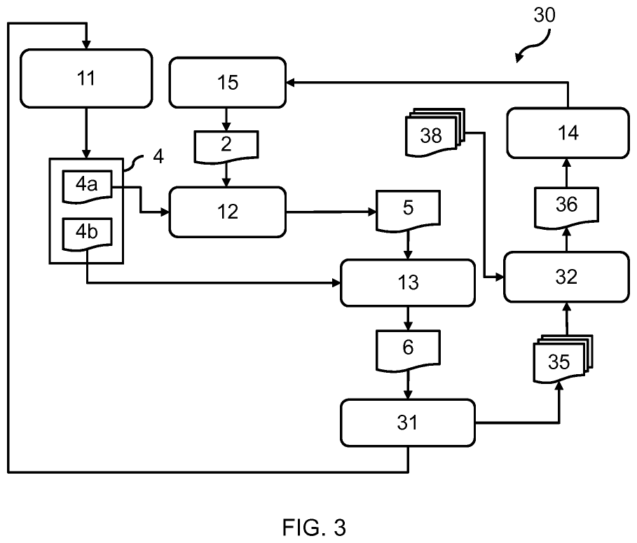

FIG. 3 is a block diagram illustrating another embodiment for a method 30 of modifying a prediction model 2.

The method 30 differs from the previously described method 1 in that the difference determination step 11, 12, 13 is iteratively repeated to generate a plurality of differences between actual answer data and corresponding predicted answer data.

In other words, multiple instances of benchmark data 4 are processed in order to determine a plurality of differences between different actual answer data and predicted answer data.

The difference determination step 11, 12, 13 may therefore comprise an additional step 31 of storing a determined difference between the actual answer data and corresponding predicted answer data, so as to build up the plurality 35 of differences. After storing the difference, the method may move to step 11 of obtaining new benchmark data 4 and repeating the determination of a difference between actual answer data and corresponding predicted answer data.

The plurality 35 of differences may correspond to a predetermined time window and/or contain a maximum number of differences. For example, the plurality 35 of differences may have a maximum capacity of 30 differences, where temporally oldest differences are discarded. Alternatively, the plurality 35 of differences may be associated only with benchmark data 4 obtained in a predetermined time window, e.g. a previous hour, day, week or month.

The method 30 further comprises a step 32 of identifying a pattern 36 in the plurality 35 of differences. For example, step 32 may comprise identifying a trend across the plurality of differences or identifying features within the plurality of differences.

In particular, step 32 may comprise identifying a pattern in the plurality of differences over time—i.e. in how the differences change over time. Such patterns are indicative of a type of drift occurring within the differences, and can indicate drift within the input data for the prediction model.

By way of example, step 32 may comprise using a neural network-based classifier to recognize whether any of a plurality of known patterns 38 are present in the plurality of differences 36.

Step 14 may comprise categorizing the inaccuracy of the prediction model based on the identified pattern in the plurality 35 of differences. That is, the identified pattern may define the category of the inaccuracy of the prediction model.

For example, each of a plurality of known patterns 38 can be associated with a different category. Step 14 may therefore comprise determining which category is associated with the identified pattern 36 (where the identified pattern is one of the known patterns 38).

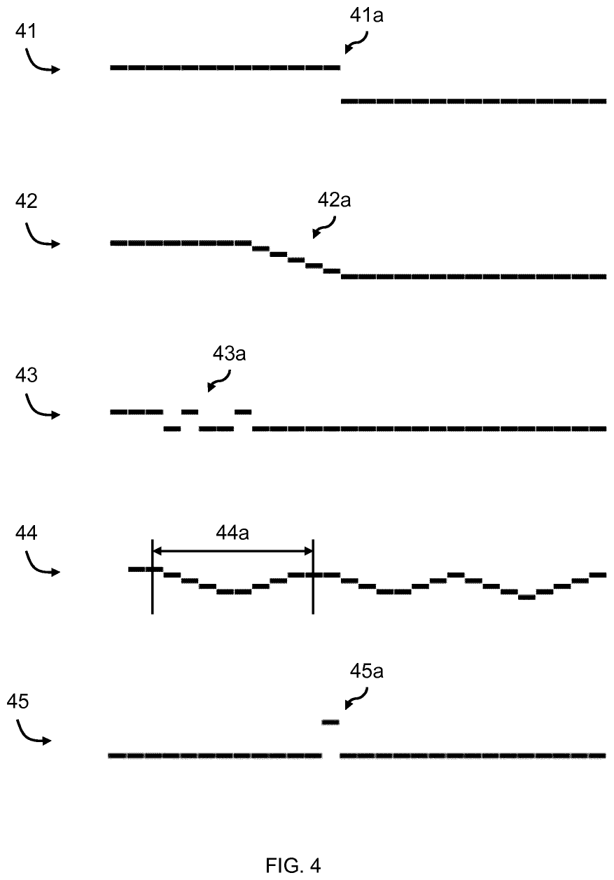

Examples of (known) patterns 38 of the plurality 35 of differences associable with different categories will be hereafter described with reference to FIG. 4, which illustrates different possible known patterns 41-45 in the plurality of differences.

In FIG. 4, each difference is modelled as a single value (e.g. an accuracy/inaccuracy measure) and the plurality of differences is plotted over time or sequentially (i.e. the differences are depicted in the order that their corresponding benchmark data were obtained).

A first pattern 41 shows a sudden or step change 41a in the value of the differences over time, in that there is a sudden drop in the differences over time. Such a pattern is indicative that a “sudden drift” in the accuracy of the prediction model, which may be indicative of a “sudden drift” or sudden change in the relationship between input data and actual answer data. For example, sudden drift can occur when something had significantly changed in the incoming benchmark data and this change is persistent for a period of time.

A second pattern 42 shows a gradual change 42a in the value of the differences over time, so that a value of the difference gradually, but steadily decreases over time. Such a pattern is indicative that there is an “incremental shift” in the accuracy of the prediction model, indicating that there is an incremental change in the relationship between input data and actual answer data of the benchmark data. For example, patient's age, outdoor temperature, or the size of the local population may gradually change in a population health management solution.

A third pattern 43 illustrates a gradual or hesitant shift 43a in the value of the differences over time, so that the value of the differences stutters when shifting from a first value to a second value over time. Such a pattern is indicative that there is a “gradual drift” in the accuracy of the prediction model.

A fourth pattern 44 illustrates a reoccurring or periodic change 44a in the value of the difference over time, so that a value of the difference changes periodically. Such a pattern is indicative that there is “periodic shift” in the accuracy of the prediction model. Such a periodic shift may, for example, represent changes to the accuracy of the prediction model over the course of a day, month or year (e.g. change in seasons). By way of example, the prevalence of respiratory infections at a population level can have seasonal fluctuations that increases the number of GP visits during a cold part of the year.

A fifth pattern 35 illustrates an outlying change 35a in the value of the differences. In other words, there is an outlier within the difference data. Such a pattern is indicative that the prediction network is generally accurate.

Thus, by using pattern recognition within a plurality of differences, a category of an inaccuracy of the prediction model can be more accurately identified, and outlying values can be advantageously ignored to avoid unnecessary modification to the prediction model.

Other possible patterns will be apparent to the skilled person. It will be clear that each pattern can thereby correspond to a different category for characterizing the inaccuracy of the prediction model.

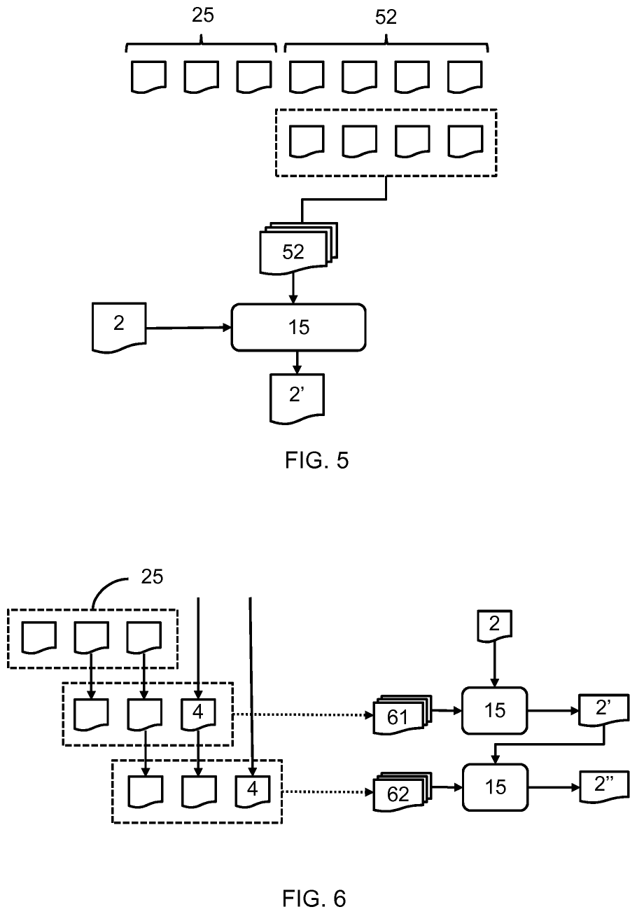

FIGS. 5 to 7 illustrates different methods for modifying a prediction model based on a categorization of the inaccuracy of the prediction model. Thus, different methods are used to modify the prediction model based on the identified category.

The illustrated methods of modifying a prediction model share a same underlying concept, in that the prediction model is retrained using modified (or new) training data. The illustrated methods differ in that the training data used to modify the prediction model differs for each category.

FIG. 5 illustrates a method of modifying a prediction model when the prediction model is categorized as being subject to a “sudden drift”, i.e. where there is a (predicted) sudden/step change in the magnitude of a difference between predicted answer data and actual answer data.

In particular, existing training data 25 (used to generate the initial prediction model 2) is discarded and new training data 52 is used, in step 15, to modify the prediction model to generate a modified prediction model 2′. In other words, the prediction model is retrained using new training data 52, i.e. not containing existing training data 25 used to generate the existing prediction model 2. Any suitable training method may be used, such as those previously described.

This is because a sudden drift indicates that the existing training data no longer accurately reflects the relationship between input data and answer data, and is therefore unreliable. New training data 25 should therefore be used to correct the prediction model 2′.

The new training data 52 may, for example, be obtained by storing the benchmark data 4. Thus, the new training data 52 may contain data entries each consisting of different benchmark data 4.

FIG. 6 illustrates a method of modifying a prediction model when the prediction model is categorized as being subject to an “incremental drift”, i.e. where there is a (predicted) gradual change in the magnitude of a difference between predicted answer data and actual answer data.

When an incremental drift is identified, a portion of existing training data 25 is used in combination with new training data 4 to modify the prediction model 2. Thus, a mixture 61 of existing training data and new training data is used to modify the prediction model. In particular, the oldest entries (i.e. temporally earliest) to the existing training data 25 may be discarded and replaced by benchmark data used to generate the difference 6 (as explained with reference to FIG. 1 or 2).

Step 15 comprises modifying the prediction model 2 based on the mixed training data 61 to generate modified prediction model 2′. This may be performed using any previously described methods.

The process of modifying the prediction model may be repeated each time new benchmark data is available. Thus, the modified prediction model 2′ may be further modified in step 15, using new mixed training data 62, to generate a further modified prediction model 2″. Thus, the mixed training data 61 is treated as being existing training data in a subsequent iteration.

In this way, modifying the prediction model comprises appending new training data to existing training data, and rebuilding a new prediction model based on the appended training data. Preferably, the modifying also comprises discarding a temporally earliest portion of the existing training data, preferably wherein the size of the discarded temporally earliest portion is a same size as the new training data appended to the existing training data.

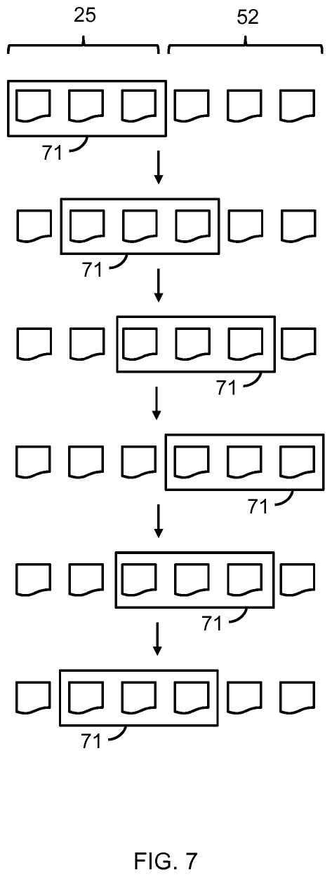

FIG. 7 illustrates a method of modifying a prediction model when the prediction model is categorized as being subject to a “periodic drift”.

A sliding window 71 is used to select the training data used to modify the prediction model, e.g. according to methods previously described. The sliding window is able to select data entries from existing training data (i.e. used to generate the original prediction model) or new training data (e.g. formed of different benchmark data 4 examples).

The sliding window 71 moves back and forth between selecting entries from the existing training data 25 and the new training data 52. In this way, the training data used to further train the prediction model periodically shifts from using existing training data to using new training data, and back again.

The periodicity of the shifting preferably corresponds to the periodicity of the drift. Modifying the prediction model may therefore comprise determining a speed at which a difference between actual answer data (of benchmark data) and corresponding predicted answer data alternates, e.g. a period of the periodic change 44a in FIG. 4, to determine a speed at which to move the sliding window.

In this way, the step of modifying the prediction model may comprise selecting a portion of existing training data and new training data (obtained from benchmark data) based on a periodicity of a periodic pattern identified in differences (corresponding to benchmark data).

Thus, the step of modifying the prediction model comprises arranging new training data within the existing training data to thereby provide integrated training data 71 that periodically switches between existing training data and new training data, and rebuilding a new prediction model based on the integrated training data.

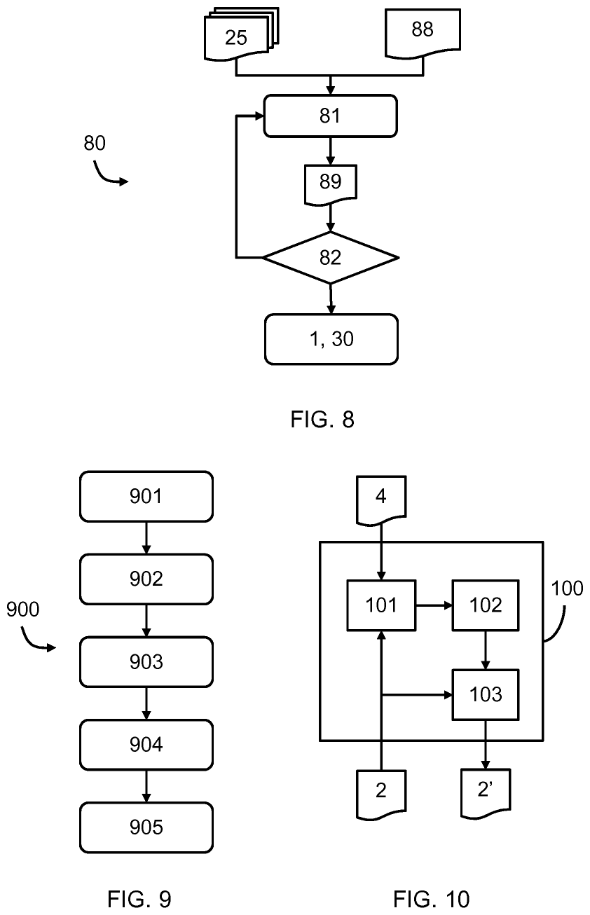

FIG. 8 illustrates a method 80 according to an embodiment of the invention, which employs any method of modifying a prediction model 1, 20 previously described. In particular, the method 80 comprises a step 81 of determining a similarity 89 between new input data 88 (to be processed by the prediction model) and existing training data 25. This may comprise, for example, performing a statistical analysis test on the new input data 88 with respect to the input data of the existing training data 25, such as a Z-test or t-test.

The method 80 further comprises a step 82 of determining, based on the similarity 89, whether to modify the prediction model. This may, for example, comprise determining whether a similarity value (such as a Z-score) is above or below a predetermined threshold—such as twice (2σ) or three (3σ) times the standard deviation of the input data of the existing training data 25.

In response to determining to modify the prediction model, any previously described prediction model modification method 1, 30 may take place. Otherwise, the method 80 reverts to the step 81 of determining a similarity 89 between (further) new input data 88.

In some examples, the new input data 88 may be replaced by new benchmark data. Step 81 may comprise determining a similarity between input data of the benchmark data and input data of the training data 25 and/or a similarity between known answer data of the benchmark test and known answer data of the training data. This similarity, or similarities, may be used in step 89 to determine whether to perform a method of modifying the prediction model (as previously described).

Using an analysis of new input data (or new benchmark data) to determine whether or not to modify the prediction model avoids unnecessary performance of the step of modifying the prediction model—thereby reducing processing power and energy.

Methods proposed above may be employed in numerous applications, where accurate prediction of answer data is desired or required.

By way of example, one area of use for prediction models is the prediction of the risk of readmission or transmission to the hospital. Typically such an assessment is performed at the time of the discharge from hospital or as a part of a home healthcare or monitoring service. For example, prediction of a risk (the predicted answer data) may be based on historical medical data of the patient and/or monitoring information (the input data). The data monitoring information may, for example, be obtained from a call center for monitoring patients/subjects (e.g. via daily telephone calls), and typically contains information about whether the patient/subject has needed or requires assistance.

In one example, a risk prediction is based on the current health status of the patient/subject s_{d}(t) at time t, and a historical sequence of events/occasions s_{c}(τₖ) where the subject/patient has required assistance or clinical attention.

The current health status typically comprises the age, gender, and self-reported health conditions of the subject/patient. It may also contain data about the subject/patient from the Electronic Medical Records (EMR) maintained by a clinical body, such as a care organization or a hospital.

The historical sequence of events may contain, for example, hospital admissions, contacts with a care provider, and automatically or manually tracked health-related events. The sequence of events is represented by a collection of cases s_{c}(τₖ) at times τₖ. It is possible to denote the collection of K historical events at time t by Cₜ={s_{c}(τₖ)}, k=0, . . . , K−1.

The risk (pₛ) at a time t can be calculated as follows:

pₛ(t)=CM(s_{d}(t),Cₜ), (1)

based upon a prediction model CM. The prediction model CM may be, for example, a logistic regression algorithm or a deep neural network.

The present invention may be useful as the methodology or software used to collect/store the health information s_{d} (t) or event information (i.e. changing the sequence of events/occasions s_{c}(τₖ)) may change or be updated, leading to a drift in the prediction model.

For example, a change in the way in which monitoring information is obtained will lead to a sudden drift in the relationship between input data and actual answer data. This is because monitoring information may be regularly updated for each known subject/patient (e.g. due to daily telephone calls for each subject/patient), so that the nature of the input data suddenly changes—leading to a change in the relationship between input data and actual answer data.

In another example, there may be a change in the way how the personal health data of each subscriber is stored in the system. Such information is typically only updated if a new incident or hospital visit occurs. Therefore, at the level of the population there is an incremental drift—as not all subject/patients will have incidents and/or hospital visits at a same time. In this way, there is only a slow drift or change in the relationship between input data and actual answer data.

Thus, it will be clear that there are different types of drift that may occur. These different types of drift may therefore affect the accuracy of the prediction model. Use of the present invention enables such changes and the characterization of such changes to be automatically detected and for the model to be recalibrated to improve an accuracy of prediction.

The proposed invention need not be limited to only classic predictive models working on numeric data, but can also be applied to other domains or for data types, such as images or natural language text. For example, with advances in deep learning, automatic methods of image analysis (such as semantic segmentation or classification) are being adopted for use in clinical decision support systems. Typically, prediction models are trained on a labeled (i.e. example actual answer data) data set of images (i.e. example input data), for example MRI or CT scans or digital pathology images. In case of semantic segmentation, the labels represent contours or shapes (“masks”) of objects of interest, such as tumors or cell nuclei. The prediction model is trained to predict the mask for a given image, i.e. to detect if the tumor is present and, if so, determine its shape (i.e. predict an answer to a predetermined question: “is a tumor present? If so, what shape is it?”).

Models are typically trained on a particular anatomy and tumor type, as the ability to correctly generalize to other anatomies/tumor types is limited. Nevertheless, even if a model was trained to detect tumors in the brain, it will still attempt to identify tumors in any image it is given as input. Thus, if a liver scan with fibrosis will be presented to such a prediction model, it will predict something, but the accuracy of this prediction would be significantly reduced (i.e. compared to a brain scan).

In order to make sure that model predictions are meaningful, it is desirable to monitor the properties of incoming input (image) data, flag the situations when this input (image) data is significantly different from training data, and, finally, to select an appropriate model adaptation strategy for the input image data.

The strategies described in the present invention can be applied to such an image analysis case as well. When actual answer data (e.g. ground truth labels) is available, it is possible to monitor a prediction model's accuracy and flag significant deviations. As previously explained, it is possible to either use statistical properties of training data or implement a deep neural network-based anomaly detection system.

For example, a neural network may learn the representation of the training data (encoding), and use it to detect input data that is significantly different from the training data. Neural network-based unsupervised anomaly detection system may also provide information about the severity of the drift (or drift type), and this information may be used to guide model adaptation. Depending on the drift severity, either retraining from scratch or partial training (“fine-tuning”) may be required for the prediction model. Thus, methods according to previously described embodiments may be employed.

Similarly to image data, concept drift detection and adaptation strategies described in the present invention may also be applied in a natural language text analysis domain.

Medical notes may contain various terminology nuances, abbreviations and other uncertainties. In order to make sure that a prediction model is still giving accurate predictions when it sees data from different doctors, clinics or diseases, it is desirable to monitor the incoming data properties and distribution of predicted values, and adapt the predictive model to the new data nuances. Thus, for dealing with the drifts in incoming data, unsupervised neural network-based anomaly detection methods can be used (as previously described). Again, depending on the severity and type of drift, different model adaptation strategies may be selected.

It has previously been described how a (concept) drift of incoming/input data can cause a drift or change in the accuracy of a prediction model, as the prediction model will not be able to effectively map between the input data and a correct answer data. There is therefore a desire to accurately identify a drift of input data, which can be used to control whether the prediction model needs to be modified.

However, detection of a drift in input data is a complex task, especially if the input data comprises textual data. A first step in determining a change or drift of input data is to determine or identify changes or transitions of concepts between two instances of textual input data.

There is proposed a method of characterizing concept drift within textual input data, by utilizing a new concept of an “attention flow model”. The attention flow model indicates how attention to a plurality of topics changes over time and to different instances of textual input data.

FIG. 9 illustrates a method 900 according to an embodiment of the invention.

The method 900 comprises a step 901 obtaining a plurality of topic vectors, each topic vector numerically representing a predetermined topic or concept so that a set of predetermined topics are represented by the plurality of topic vectors

The method 900 also comprises a step 902 of measuring a similarity between each topic vector and each other topic vector to thereby provide a plurality of similarity measures.

The method 900 also comprises a step 903 of obtaining first textual input data and second, different textual input data.

The method 900 also comprises a step 904a of obtaining a first set of weights (each weight indicating a weighting of a respective topic of the set of predetermined topics within the first textual input data) and a step 904b of obtaining a second set of weights (each weight indicating a weighting of a respective topic of the set of predetermined topics within the second textual input data). The number of weights in the first and second set are the same and identical to the number of predetermined topics.

The method 900 also comprises a step 905 of determining a plurality of attention flow measures, each attention flow measure representing an attention flow from a respective predetermined topic within the first textual input data to a respective predetermined topic within the second textual input data. The determining is based on the similarity measure associated with the respective predetermined topics and the weight, of the first set of weights, associated with the respective predetermined topic within the first textual input data and the weight, of the second set of weights, associated with the respective predetermined topic within the second textual input data.

A specific working example of the method 900 is hereafter described, but the skilled person would be readily capable of adapting the described concepts appropriately.

In an example, each of the first and second textual input data (obtained in step 903) may each comprises a corpus of text documents associated with a respective point in or period of time. For example, the first textual input data may comprise a corpus of text documents published in a first month and the second textual input data may comprise a corpus of text documents published in a second, different month (e.g. a month immediately following the first month).

Each time-stamped corpus of text documents may be obtained and pre-processed, e.g. by a document pre-processor. The pre-processing comprises at least a step of extracting metadata of the text documents, and may further comprise one or more steps of: deleting stop-words; stemming, providing lemmatization; and providing tokenization. The output (of the document pre-processor) is a processed text corpus along with corresponding metadata. The pre-processing may form part of step 903 of obtaining the first and second textual input data.

In one example, pre-processing comprises processing a corpus of text documents using the spaCy pipeline proposed by Matthew Honnibal and Ines Montani in spacy 2: Natural language understanding with bloom embeddings, convolutional neural networks and incremental parsing. The spaCy pipeline provides normalization, tokenization, constituency parsing, partial speech tagging, email and url filtering.

Pre-processing may further comprise using Arc-Eager dependency parsing, such as that suggested by Yoav Goldberg and Joakim Nivre in “A dynamic oracle for arc-eager dependency parsing” Proceedings of COLING 2012, pages 959-976, 2012. This process merges noun phrases into a single token (e.g, “Great Bear”).

The pre-processing step can encode a plurality of documents by building up a dictionary, in which where keys are tokens and values are integer numerical identifiers, wherein each document is represented as a sequence of token identifiers.

The (pre-processed) first and second textual inputs are then processed in steps 904a and 904b to determine a set of weights for each textual input, each weight indicating a relative measure of a respective topic (represented by a topic vector) within the textual input.

This step may be performed using any topic extractor methodology, which is capable of determining a relative weight of predetermined topics within textual input data. A topic can be represented by a topic vector, so that there can be a plurality of topic vectors each representing a predetermined topic (e.g. to be obtained in step 901).

To establish the predetermined topic, the first and second textual input data may be together processed with a topic extractor methodology capable of outputting a set of topics. This may define the plurality of predetermined topics, e.g. in step 901.

One example of a suitable topic extractor methodology is the lda2vec algorithm described by Christopher Moody in “Mixing dirichlet topic models and word embeddings to make lda2vec” Eprint arXiv:1605.02019, 2016. This approach combines ideas of word2vec and topic models, in particular latent Dirichlet allocation and is designed for simultaneous word and document interpretable modeling.

The lda2vec algorithm is based on topic-driven modeling hypothesis, and introduces three parameters: word vectors, topic vectors and a document topic distribution vector. A word vector is a vector that represents a word of a document, so that a cosine of two word vectors is indicative of the similarity between two words. A topic vector is a vector that represents a topic, so that a cosine of two topic vectors is indicative of a similarity between two topics. A document topic distribution vector indicates a weighting or weight vector of each of a predetermined set of topics (associated with a topic vector) within a particular document.

It will be appreciated that each word/entry in a vocabulary (i.e. representing any possible word of a document or textual input) has a corresponding word vector.

The lda2vec algorithm is adapted to assign a topic distribution vector to each textual input (e.g. document), and has t components or weight vectors (where t is the number of topics) and indicates which topics are discussed in said document. Accordingly, there are t topic vectors.

In order to calculate word vectors, topic vectors and topic distributions, LDA2Vec formulates “predictive context hypothesis”. It is asserted that, for any word in the document, its corresponding word vector should be similar (have a high cosine similarity) to the sum of the word vector representing the previous word and the document vector (being weighted sum of topic vectors for topics discussed in the document). Jointly this sum is known as context vector. Stochastic gradient descent is then used to calculate the optimal word vectors, topic vectors and document-topic distributions, but any other optimization method can be applied interchangeably.

As a result, when the first and second textual inputs are processed using the lda2vec approach, there exists (for each textual input “i”) a discrete topic distribution over a finite set of topics encoded as set of weights or weight vector “wᵢ”. Each component “w_{t,i}” of the weight vector “wᵢ” thereby represents the popularity of a topic “t” within the textual input i.

The present invention proposes to determine a measure of attention flow between (topics of) the first and second textual inputs. In other words, there is a desire to determine how focus upon particular topics changes between the first and second textual inputs.

Hereafter, the first textual input can be referred to by the parameter “i” and the second textual input can be referred to by the parameter “i+1”. This may be indicative of a time difference between the first and second textual inputs.

The attention flow represents a flow of attention between a source topic s of the first textual input i (associated with a weight w_{s, i}) and a target topic t of the second textual input i+1 (associated with a weight w_{t, i+1}).

The attention flow can be modelled as a non-negative parameter w_{s,t,i}. Attention flow is non-negative as it is conceptually impossible for a negative attention flow to occur. The inventors have recognized that it is more conceptually more likely that attention is more likely to flow between similar topics than dissimilar topics.

A similarity between topics can be calculated using a cosine similarity as follows:

Similarity=cos(Rₛ,Rₜ) (2)

where Rₛ is the topic vector associated with a “source” topic s and Rₜ is the topic vector associated with a “target” topic t. Cosine similarity of a given topic with itself cos(Rs;Rs)=1, hence attention is more likely to stay on the same topic than shift. Other methods of measuring a similarity between two topics (or topic vectors) are envisaged.

We use this hypothesis to define the following equation:

ω_{s,t,i}=cos(Rₛ,Rₜ)ω̅_{s,t,i} (3)

Drawing an analogy with electrical current (representing ω_{s,t,i}), the reciprocal of cos(Rₛ, Rₜ) effectively represents “resistance” of a certain transition (i.e. attention flow) and ω̅_{s,t,i} represents its “voltage”. In another analogy, cos(Rₛ, Rₜ) is the potential of attention flow from topic s to topic t and ω̅_{s,t,i} represents how much this potential is used. The “source” topic s is associated with the first textual input, with the target topic s being associated with the second textual input.

It is also possible to hypothesize that some topics may just some topics may emerge “out of nowhere”, whilst others may naturally “die” without any shift to one or several different topics. These hypotheses are respectively represented by a birth transition:

b_{t,i}=βb̅_{t,i} (4)

and a death transition:

d_{s,i}=δd̅_{s,i} (5)

in which β and δ are hyperparameters that define how likely spontaneous birth and death is. Setting them to 0 means that attention can only shift from one topic to another, but never escapes the loop. Setting them to 1 or more means that topic distribution at time i+1 is independent of topic distribution at time i.

Using these defined equations, it is possible to create an attention flow model as follows:

$${w}_{s , i} = {d}_{s , i} + {\sum }_{t} {ω}_{s , t , i} = δ {\overline{d}}_{s , i} + {\sum }_{t} cos ( {R}_{s} , {R}_{t} ) {\overline{ω}}_{s , t , i} \\ {w}_{t , i + 1} = {b}_{t , i} + {\sum }_{s} {ω}_{s , t , i} = β {\overline{b}}_{t , i} + {\sum }_{s} cos ( {R}_{s} , {R}_{t} ) {\overline{ω}}_{s , t , i} ∀ s , t , i \text{:} {\overline{ω}}_{s , t , i} {\overline{b}}_{t , i} {\overline{d}}_{s , i} \geq 0 \qquad ( 6 )$$

It is hypothesized that attention follows the path of least resistance. Thus, the attention flow model can be processed using linear programming (or any other convex optimization or parameter minimizing method) to find values of variables ω̅_{s,t,i}, b̅_{t,i}, d̅_{s,i} that yields the minimum of the objective function:

$${min}_{\overline{ω} , \overline{b} , \overline{d}} \{ {\sum }_{s , t , i} {\overline{ω}}_{s , t , i} + {\sum }_{s , i} {\overline{b}}_{s , i} + {\sum }_{t , i} {\overline{d}}_{t , i} \} \qquad ( 7 )$$

within the constraints of the attention flow model (set out in (6)). This process enables us to calculate, between each topic in the first textual input and each topic in the second textual input, a measure of attention flow w_{s,i}.

Use of the linear programming effectively carries out steps 902 and 905 of method 900, as the similarity measures are calculated during the execution of the linear optimization program (when constrained by the attention flow model).

The birth and death transitions are optional, and can be omitted from the attention flow model, but this would provide a less representative or realistic interpretation of changes in attention between topics.

Although embodiments have only been described with reference to a first and second textual input, embodiments may extend to determining a further attention flow between the second textual input and a third textual input and optionally to determining a yet further attention flow between the third textual input and a fourth textual input (and so on). Thus, methods can extend to determining an attention flow between an Nth textual input and an (N+1)th textual input. In other words, provided that appropriate weighting vectors or topic distributions w₁ . . . wᵢ for i input textual inputs can be generated, then any number of attention flow calculations can be made.

The attention flow model also allows for prediction of future topic trends and attention flow. In particular, given the topic distributions (weighting vectors) w₁ . . . wᵢ it is possible to estimate what the next topic distribution wᵢ₊₁, for a hypothetical textual input, is likely to be. In this way, we can predict which topics are likely to be more heavily weighted in the future.

From the attention flow model shown in (6), it is possible to recall that:

$${w}_{t , i + 1} = {b}_{t , i} + {\sum }_{s} {ω}_{s , t , i} \qquad ( 8 )$$

Hence, one can predict a future weighting vector ŵᵢ₊₁, by predicting \hat{b}_{t,i} and \hat{ω}_{s,t,i}. If we apply the attention flow model to known topic distributions w₁ . . . wᵢ and minimize function (7), we obtain attention flow values ω_{s,t,ī} and spontaneous birth values b_{t,ī} for ī=1, 2 . . . i.

The prediction model may be based on the assumption that this values have inertia and don't significantly change too much from time moment i to time moment i+1. To formalize this assumption, we use exponential moving average (ema) defined recursively as:

ema(ω_{s,t})₁=ω_{s,t,1}

ema(bₜ)₁=b_{t,1}

ema(wₜ)₁=w_{t,i}

ema(w_{s,t})=ϑω_{s,t,i}+(1−ϑ)ema(ω_{s,t})ᵢ₋₁

ema(bₜ)ᵢ=ϑb_{t,i}+(1−ϑ)ema(bₜ)ᵢ₋₁

ema(wₜ)ᵢ=ϑw_{t,i}+(1−ϑ)ema(wₜ)ᵢ₋₁ (9)

where ϑ is a hyperparameter of the predictive model that indicates how long term its memory is.

Applying these formulas (9) iteratively until i=0 gives us naive prediction for attention flows and spontaneous birth at time moment i+1, in which \hat{ω}_{t,i+1}=ema(\hat{ω}_{s,t}), and \hat{b}_{t,i}=ema(bₜ)ᵢ.

The naive prediction, however, does not take into account the distribution of topics at time moment preceding the one we are trying to predict and might therefore violate an outflow constraint d_{s,i}=w_{t,i}−Σₜw_{s,t,i}≥0 (i.e. it can undesirably predict that more attention flows away from a topic than the topic actually had).

A modified version, labelled “adjusted average attention flow”, can be used to avoid this problem.

$${\hat{w}}_{t , i + 1} = e m {a ( {b}_{t} )}_{i - 1} + {\sum }_{s} e m {a ( {ω}_{s , t} )}_{i - 1} \frac{{w}_{s , i}}{e m {a ( {w}_{s} )}_{i - 1}} \qquad ( 10 )$$

In this model, the predicted attention flow

$${\hat{ω}}_{s , t , i} = e m {a ( {ω}_{s , t} )}_{i - 1} \frac{{w}_{s , i}}{em {a ( {w}_{s} )}_{i - 1}}$$

represents long-term memory that takes into account all activity since time moment i=1. ω_{s,i} represents short term memory that only includes the last iteration.

Since the attention flows ω_{s,t,1} . . . ω_{s,t,i-1} comes from constrained optimization, they satisfy the outflow constraint w_{t,i}−Σₜw_{s,t,i}. Hence:

$$e m {a ( {w}_{s} )}_{i - 1} - {\sum }_{t} {ema ( {ω}_{s , t} )}_{i - 1} \geq 0 \\ {w}_{s , i} e m {a ( {w}_{s} )}_{i - 1} - {w}_{s , i} {\sum }_{t} em {a ( {ω}_{s , t} )}_{i - 1} \geq 0 \\ {w}_{s , i} - \frac{{w}_{s , i}}{e m {a ( {w}_{s} )}_{i - 1}} {\sum }_{t} em {a ( {ω}_{s , t} )}_{i - 1} \geq 0 \\ {w}_{s , i} - {\sum }_{t} em {a ( {ω}_{s , t} )}_{i - 1} \frac{{w}_{s , i}}{e m {a ( {w}_{s} )}_{i - 1}} \geq 0 \\ {w}_{s , i} - {\sum }_{t} {\hat{ω}}_{s , t , i} \geq 0 \qquad ( 11 )$$

Thus, it can be confirmed that the predicted attention flow(s) satisfy the outflow constraint as well.

FIG. 10 illustrates a system 100 adapted for modifying a prediction model 2. As before, the prediction model is generated based on existing training data and is adapted to process input data to generate predicted answer data indicative of a predicted answer to a predetermined question concerning the input data.

The system 100 comprises a difference determination module 91 adapted to perform a difference determination step. This step is performed by the difference determination module 101: receiving benchmark data 4, the benchmark data comprising example input data and corresponding actual answer data indicative of an actual or known answer to the predetermined question concerning the corresponding example input data; using the prediction model 2 to process the example input data to generate predicted answer data indicative of a predicted answer to the predetermined question based on the example input data; and determining a difference between the actual answer data and the predicted answer data.

The system 100 also comprises a categorization unit 102 adapted to categorize an inaccuracy of the prediction model into one of at least three categories based on at least the difference between the actual answer data and the predicted answer data.

The system 100 also comprises a modification unit 103 adapted to modify the prediction model 2 based on the category of inaccuracy of the prediction model, thereby generating a modified prediction model 2′.

In some embodiments, the difference determination module 101 is adapted to iteratively repeat the difference determination step to thereby generate a plurality of differences between actual answer data and corresponding predicted answer data. Accordingly, the categorization unit 102 may be adapted to categorize the inaccuracy of the prediction model by identifying a pattern in the plurality of differences and categorizing the inaccuracy based on the identified pattern in the plurality of differences.

The present invention may be a system, a method, and/or a computer program product. The computer program product may include a computer readable storage medium (or media) having computer readable program instructions thereon for causing a processor to carry out aspects of the present invention. The computer readable storage medium can therefore be a tangible device that can retain and store instructions for use by an instruction execution device, such as a controller, processor or processing system, for executing a method according to the present invention. Disclosed methods may therefore be computer-implemented methods.

The present invention is described herein with reference to flowchart illustrations and/or block diagrams of methods, apparatus (systems), and computer program products according to embodiments of the invention. Each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. Each block in the flowchart or block diagrams may represent a module, segment, or portion of instructions, comprising one or more executable instructions for implementing the logical function(s).

In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A computed-implemented method of modifying a prediction model, wherein the prediction model is generated based on existing training data and is adapted to process input data to generate predicted answer data indicative of a predicted answer to a predetermined question concerning the input data, wherein the method comprises:
performing a difference determination step comprising:
receiving benchmark data, the benchmark data comprising example input data and corresponding actual answer data indicative of an actual or known answer to the predetermined question concerning the corresponding example input data;
using the prediction model to process the example input data to generate predicted answer data indicative of a predicted answer to the predetermined question based on the example input data; and
determining a difference between the actual answer data and the predicted answer data,
categorizing an inaccuracy of the prediction model into one of at least three categories based on at least the difference between the actual answer data and the predicted answer data; and
modifying the prediction model based on the category of inaccuracy of the prediction model wherein:
the difference determination step is iteratively repeated to generate a plurality of differences between actual answer data and corresponding predicted answer data; and
the step of categorizing the inaccuracy of the prediction model comprises:
identifying a pattern in the plurality of differences, comprising identifying whether there is a step change in the differences and identifying if there is a gradual change in the differences; and
categorizing the inaccuracy based on the identified pattern in the plurality of differences, wherein the inaccuracy is categorized as a sudden drift if there is a step change in the differences and is categorized as a gradual drift if there is a gradual change in the differences.

2. (canceled)

3. (canceled)

4. The computed-implemented method of claim 1, wherein in response to categorizing the inaccuracy as a sudden drift, the step of modifying the prediction model comprises rebuilding a new prediction model based on new training data for the prediction model.

5. The computed-implemented method of claim 1, wherein determining whether there is a step change in the differences over time comprises determining whether a standard deviation of the differences during a time window is greater than a first predetermined value.

6. (canceled)

7. The computed-implemented method of claim 1, wherein in response to categorizing the inaccuracy as a gradual drift, the step of modifying the prediction model comprises appending new training data to existing training data, and rebuilding a new prediction model based on the appended training data.

8. The computed-implemented method of claim 7, wherein the step of modifying the prediction model further comprises discarding a temporally earliest portion of the existing training data, preferably wherein the size of the discarded temporally earliest portion is a same size as the new training data appended to the existing training data.

9. The computed-implemented method of claim 1, wherein determining whether there is a gradual change in the differences comprises determining whether a standard deviation of the differences during a time window is between a second predetermined value and a third predetermined value.

10. The computed-implemented method of claim 1, wherein
the step of identifying a pattern in the plurality of differences comprises determining whether there is a periodic change in the differences;
in response to determining that there is a periodic change in the differences, the step of categorizing the inaccuracy comprises categorizing the inaccuracy as a periodic drift.

11. A computed-implemented method of modifying a prediction model, wherein the prediction model is adapted to process input data to generate predicted answer data indicative of a predicted answer to a predetermined question based on the input data, the method comprising:
determining between new input data for the prediction model and the existing training data used to train the prediction model;
determining whether to modify the prediction model based on the determined similarity between the new input data and the existing training data; and
in response to determining to modify the prediction model, performing the method of claim 1.

12. The computed-implemented method of claim 11, wherein the step of determining a similarity between new input data and existing training data comprises determining a similarity between statistical distributions of the new input data and the existing training data.

13. A computer program comprising code means for implementing the method of claim 1 when said program is run on a computer.

14. A system adapted for modifying a prediction model, wherein the prediction model is generated based on existing training data and is adapted to process input data to generate predicted answer data indicative of a predicted answer to a predetermined question concerning the input data, wherein the system comprises:
a difference determination module adapted to perform a difference determination step by:
receiving benchmark data, the benchmark data comprising example input data and corresponding actual answer data indicative of an actual or known answer to the predetermined question concerning the corresponding example input data;
using the prediction model to process the example input data to generate predicted answer data indicative of a predicted answer to the predetermined question based on the example input data; and
determining a difference between the actual answer data and the predicted answer data,
a categorization unit adapted to categorize an inaccuracy of the prediction model into one of at least three categories based on at least the difference between the actual answer data and the predicted answer data; and
a modification unit adapted to modify the prediction model based on the category of inaccuracy of the prediction model;
wherein the difference determination module is adapted to iteratively repeat the difference determination step to thereby generate a plurality of differences between actual answer data and corresponding predicted answer data; and
the categorization unit is adapted to categorize the inaccuracy of the prediction model by:
identifying a pattern in the plurality of differences, comprising identifying whether there is a step change in the differences and identifying if there is a gradual change in the differences; and
categorizing the inaccuracy based on the identified pattern in the plurality of differences, wherein the inaccuracy is categorized as a sudden drift if there is a step change in the differences and is categorized as a gradual drift if there is a gradual change in the differences.

15. (canceled)

16. The computed-implemented method of claim 7 wherein
in response to categorizing the inaccuracy as a periodic drift, the step of modifying the prediction model comprises obtaining new training data and iteratively modifying the prediction model by iteratively:
obtaining integrated training data formed of a portion of the existing training data and a portion of the new training data;
modifying the prediction model based on the integrated training data,
wherein the size of the portion of the new training data and the size of the portion of the existing training data in the integrated training data is modified for each iteration of modifying the prediction model.
